(19) United States
(12) Patent Application Publication
(10) Pub. No.: US 2024/0378454 A1
(43) Pub. Date: Nov. 14, 2024

(54) OPTIMIZING MODELS FOR OPEN-VOCABULARY DETECTION

(71) Applicant: NEC Laboratories America, Inc., Princeton, NJ (US)

(72) Inventors: Samuel Schulter, Long Island City, NY (US); Yumin Suh, Santa Clara, CA (US); Manmohan Chandraker, Santa Clara, CA (US); Vijay Kumar Baikampady Gopalkrishna, Santa Clara, CA (US)

(21) Appl. No.: 18/659,738

(22) Filed: May 9, 2024

Related U.S. Application Data
(60) Provisional application No. 63/465,607, filed on May 11, 2023.
(60) Provisional application No. 63/466,827, filed on May 16, 2023.
(60) Provisional application No. 63/599,137, filed on Nov. 15, 2023.

(51) Int. Cl. G06N 3/096

(52) U.S. Cl. CPC G06N 3/096

(57) ABSTRACT

Systems and methods for optimizing models for open-vocabulary detection. Region proposals can be obtained by employing a pre-trained vision-language model and a pre-trained region proposal network. Object feature predictions can be obtained by employing a trained teacher neural network with the region proposals. Object feature predictions can be filtered above a threshold to obtain pseudo labels. A student neural network with a split-and-fusion detection head can be trained by utilizing the region proposals, base ground truth class labels and the pseudo labels. The pseudo labels can be optimized by reducing the noise from the pseudo labels by employing the trained split-and-fusion detection head of the trained student neural network to obtain optimized object detections. An action can be performed relative to a scene layout based on the optimized object detections.

### RELATED APPLICATION INFORMATION

This application claims priority to U.S. Provisional App. No. 63/465,607 filed on May 11, 2023, U.S. Provisional App. No. 63/466,827 filed on May 16, 2023, and U.S. Provisional App. No. 63/599,137 filed on Nov. 15, 2023, incorporated herein by reference in its entirety.

### BACKGROUND

### Technical Field

The present invention relates to open-vocabulary object detection, and more particularly to systems and methods for optimizing models for open-vocabulary detection.

### Description of the Related Art

Traditional closed-set object detectors are restricted to detecting objects with a limited number of categories. Increasing the size of detection vocabularies involves heavy human labor to collect annotated data. Additionally, training object detectors with an increased detection size could lead to noisy and unreliable pseudo labels. Thus, a balance between model accuracy, efficiency, and flexibility is desired.

### SUMMARY

According to an aspect of the present invention, a method for optimizing models for open-vocabulary detection is provided, including obtaining region proposals by employing a pre-trained vision-language model and a pre-trained region proposal network, obtaining object feature predictions by employing a trained teacher neural network with the region proposals, filtering object feature predictions above a proposal threshold to obtain pseudo labels, training a student neural network with a split-and-fusion detection head by utilizing the region proposals, ground truth class labels, ground truth bounding boxes, and the pseudo labels, optimizing the pseudo labels by reducing noise from the pseudo labels by employing the trained split-and-fusion detection head of the trained student neural network to obtain optimized object detections, and performing an action relative to a scene layout with the optimized object detections.

According to another aspect of the present invention, a system for optimizing models for open-vocabulary detection is provided, having a memory, one or more processor devices in communication with the memory configured to obtain region proposals by employing a pre-trained vision-language model and a pre-trained region proposal network, obtain object feature predictions by employing a trained teacher neural network with the region proposals, filter object feature predictions above a proposal threshold to obtain pseudo labels, train a student neural network with a split-and-fusion detection head by utilizing the region proposals, ground truth class labels, ground truth bounding boxes, and the pseudo labels, optimize the pseudo labels by reducing noise from the pseudo labels by employing the trained split-and-fusion detection head of the trained student neural network to obtain optimized object detections, and perform an action relative to a scene layout with the optimized object detections.

According to another aspect of the present invention, a non-transitory computer program product comprising a computer-readable storage medium including program code for optimizing models for open-vocabulary detection is provided wherein the program code when executed on a computer causes the computer to perform obtaining region proposals by employing a pre-trained vision-language model and a pre-trained region proposal network, obtaining object feature predictions by employing a trained teacher neural network with the region proposals, filtering object feature predictions above a proposal threshold to obtain pseudo labels, training a student neural network with a split-and-fusion detection head by utilizing the region proposals, ground truth class labels, ground truth bounding boxes, and the pseudo labels, optimizing the pseudo labels by reducing noise from the pseudo labels by employing the trained split-and-fusion detection head of the trained student neural network to obtain optimized object detections by fusing the prediction scores from the closed-branch and open-branches by computing a geometric mean of the prediction scores at inference time, and performing an action relative to a scene layout with the optimized object detections.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level method for optimizing models for open-vocabulary detection, in accordance with an embodiment of the present invention.

FIG. 2 is a flow diagram illustrating a method for obtaining region proposals by employing a pre-trained vision-language model and a pre-trained region proposal network, in accordance with an embodiment of the present invention;

FIG. 3 is a flow diagram illustrating a method for obtaining object feature predictions by employing a trained teacher neural network with the region proposals, in accordance with an embodiment of the present invention;

FIG. 4 is a flow diagram illustrating a method for filtering object feature predictions above a threshold to obtain pseudo labels, in accordance with an embodiment of the present invention;

FIG. 5 is a flow diagram illustrating a method for training a student neural network with a split-and-fusion detection head by utilizing the region proposals, ground truth class labels, ground truth bounding boxes, and the pseudo labels, in accordance with an embodiment of the present invention;

FIG. 6 is a flow diagram illustrating a method for optimizing pseudo labels by reducing noise from the pseudo labels by employing the trained split-and-fusion detection head of the trained student neural network, in accordance with an embodiment of the present invention;

FIG. 7 is a block diagram illustrating an overview of a system for optimizing models for open-vocabulary detection, in accordance with an embodiment of the present invention;

FIG. 8 is a block diagram illustrating a system for optimizing models for open-vocabulary detection, in accordance with an embodiment of the present invention;

FIG. 9 is a flow diagram illustrating a system for method for optimizing models for open-vocabulary detection, in accordance with an embodiment of the present invention; and

FIG. 10 is a flow diagram illustrating an overview of deep learning neural networks, in accordance with an embodiment of the present invention.

### DETAILED DESCRIPTION OF PREFERRED EMBODIMENTS

In accordance with embodiments of the present invention, systems and methods are provided for optimizing models for open vocabulary detection.

The present embodiments can optimize models for open vocabulary detection. In an embodiment, a pre-trained vision-language model (VLM) and a pretrained external region proposal network (RPN) can be employed to obtain region proposals. In an embodiment, object feature predictions can be obtained by employing a trained teacher neural network with the region proposals. In an embodiment, object feature predictions can be filtered above a threshold to obtain pseudo labels. In an embodiment, a student neural network with a split-and-fusion detection head can be trained by utilizing the region proposals, ground truth class labels, ground truth bounding boxes, and the pseudo labels. In an embodiment, the pseudo labels can be optimized by reducing noise from the pseudo labels by employing the trained split-and-fusion (SAF) detection head of the trained student neural network to obtain optimized object detections. In an embodiment, an action can be performed relative to a scene layout with the optimized object detections. In an embodiment, the teacher neural network can be periodically updated with parameters of the student neural network.

In an embodiment, the action can be changing driving behavior relative to a traffic scene layout. In another embodiment, the action can be creating an interior design plan relative to an interior design scene layout. In another embodiment, the action can be creating an exterior design plan relative to an exterior design scene layout. In another embodiment, the action can be controlling the vehicle relative to a traffic scene layout.

The SAF detection head can circumvent noisy locations of pseudo labels and bounding boxes by reducing the accumulation of noise during self-training. In an embodiment, the SAF detection head can be employed to optimize pseudo labels by reducing the noise of pseudo labels. In an embodiment, the SAF detection head can split a detection head into two branches: the closed-branch and the open-branch, which are fused at inference. In an embodiment, the closed-branch can include a classification module and a box refinement module. In an embodiment, the closed-branch can be trained solely with ground truth class labels from base categories, which can mitigate the impact of noisy pseudo labels on the performance of base categories. In an embodiment, the open-branch can be a classification module trained with ground truth class labels and pseudo labels. In an embodiment, the open-branch can acquire complementary knowledge from the closed-branch and can significantly boost the performance when fused with the closed-branch.

With the recent advent of strong vision and language models (VLMs), open-vocabulary object detection (OVD) provides an alternative direction to approach this challenge. OVD detectors are trained with annotations of base categories and are expected to generalize novel target categories by leveraging the power of pretrained VLMs. Recent studies for OVD leverages VLMs to obtain pseudo labels beyond base categories but overlook self-training. Given an image, an object detection model can localize objects for any category name that can be provided as a free-form text, and need not be part of the object detection training data (e.g., including a bounding box annotation). Large vision-language models (VLM) can be trained with enormous amounts of image-caption pairs, which can be easily collected at large scale. While VLMs have capable zero-shot classification ability, they cannot localize objects in images.

Self-training in closed-set tasks sets a confidence threshold to remove noisy pseudo labels because the quality of pseudo labels is positively correlated to their confidences. However, VLMs employed in OVD are pretrained for image-level alignment with texts instead of instance level object detection that involves localization. Thus, the confidence score from pretrained VLMs is usually not a good indicator of the quality of box locations (e.g., pseudo boxes) provided by pseudo labels. This issue worsens when self-training is applied directly, as the noise accumulates and degrades the performance on novel categories. Moreover, these methods handle noisy pseudo labels in the same way as ground truth class labels of base categories during training, which further decreases the performance on base categories.

Furthermore, self-training for closed-set object detection usually follows an online teacher-student manner. In each training iteration, the teacher generates pseudo labels, and the student is trained with a mixture of ground truth class labels and pseudo labels. Then, the teacher is updated by the student with exponential moving average (EMA). However, EMA updates degrade OVD models which makes training unstable.

The present embodiments can optimize VLMs for open-vocabulary detection. By separating detection heads and periodically updating the teacher neural network, the present embodiments can produce pseudo labels more efficient than prior methods by mitigating the degradation found when updating with EMA. Thus, the present embodiments can balance the accuracy, efficiency, and flexibility of open-vocabulary object detection models by employing the SAF detection head and periodically updating the teacher neural network.

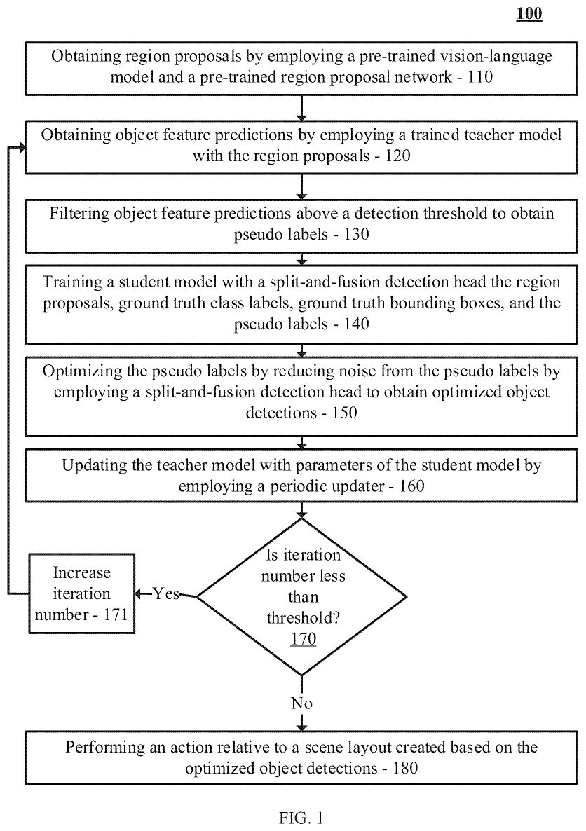

Referring now in detail to the figures in which like numerals represent the same or similar elements and initially to FIG. 1, a high-level overview of a method for optimizing models for open-vocabulary detection 100 is illustratively depicted, in accordance with one embodiment of the present invention.

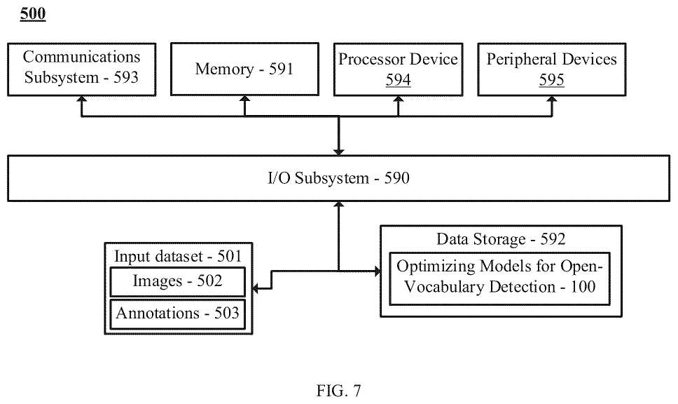

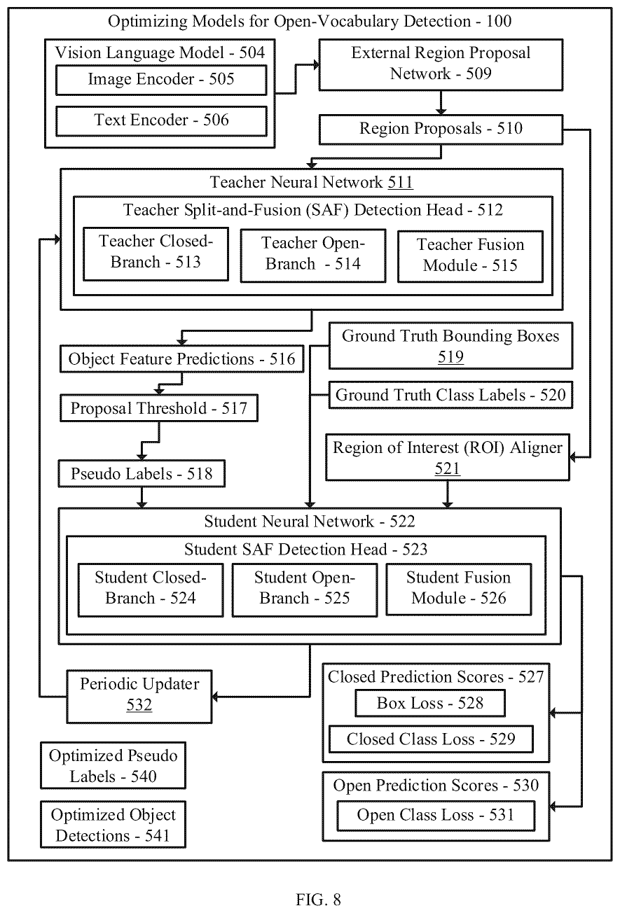

In an embodiment, a vision-language model 504 (shown in FIG. 8) and an external region proposal network 509 (shown in FIG. 8) can be employed to obtain region proposals 510 (shown in FIG. 8). In an embodiment, a teacher-student architecture can be employed where the teacher neural network 511 (shown in FIG. 8) can generate pseudo labels 518 (shown in FIG. 8) for an arbitrary list of categories. In an embodiment, the student neural network 522 (shown in FIG. 8) utilizes the pseudo labels 518, together with an input dataset 501 (shown in FIG. 7) for training. In an embodiment, teacher neural network 511 can employ split-and-fusion detection head 512 (shown in FIG. 8). In an embodiment, the student neural network 522 can employ split-and-fusion detection head 523 (shown in FIG. 8) to optimize the pseudo labels 518 to obtain optimized pseudo labels 540 (shown in FIG. 8).

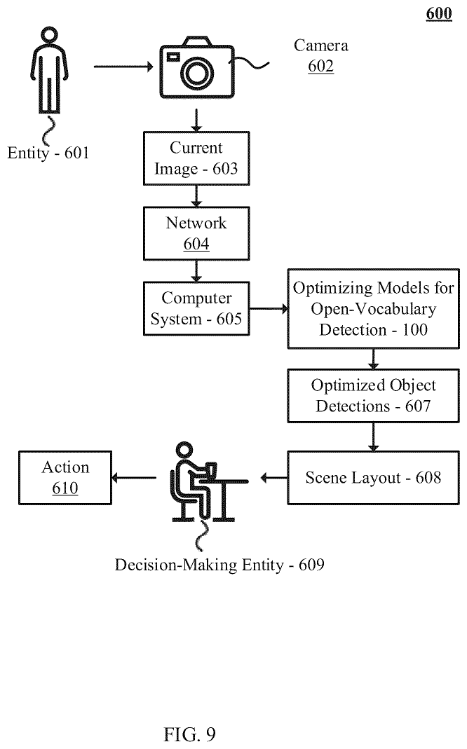

In an embodiment, the detection heads can be split into separate branches, which can be supervised in a different way. In an embodiment, a closed-branch (e.g., teacher closed branch 513 and student closed-branch 524 as shown in FIG. 8) can be supervised with closed-set detection data (e.g., ground truth class labels 520, ground truth bounding boxes 519 as shown in FIG. 8). In an embodiment, an open-branch (e.g., teacher open branch 514 and student open-branch 525 as shown in FIG. 8) can be employed for classification and can be trained with the ground truth class labels 520 (shown in FIG. 8) and the pseudo labels 518. The optimized pseudo labels 540 correspond with the optimized object detections 541. In an embodiment, a scene layout 608 (shown in FIG. 9) can be created based on the optimized object detections 541.

In block 110, region proposals 510 can be obtained by employing a pre-trained vision-language model 504 and a pre-trained region proposal network 509.

In block 120, a teacher neural network 511 can be trained with the region proposals 510 to obtain object feature predictions 516.

In block 130, the object feature predictions 516 can be filtered against a proposal threshold 517 (shown in FIG. 8) to obtain pseudo labels 518.

In block 140, a student neural network 522 with a split-and-fusion detection head 523 can be trained with the region proposals 510, ground truth class labels 520 and the pseudo labels 518.

In block 150, the pseudo labels 518 can be optimized by reducing noise from the pseudo labels 518 by employing a split-and-fusion head 523 to obtain optimized object detections 541 (shown in FIG. 8).

In block 160, the teacher neural network 511 can be updated with the parameters of the student neural network 522 by employing a periodic updater 532 (shown in FIG. 8).

In block 170, an iteration number is checked whether it is less than a threshold. If the iteration number is less than the threshold, the iteration number is increased in block 171 and the process goes back to block 120 with the teacher neural network 511 having updated parameters. Otherwise, the process continues to block 180. In an embodiment, the threshold can be a pre-determined number based on a learning rate schedule of the teacher neural network 511. For example, the threshold can be 3.

In block 180, an action 610 can be performed relative to a scene layout 608 created based on the optimized object detections 541. In an embodiment, the scene layout 608 can be interpreted by a decision-making entity to execute an action 610 (shown in FIG. 9). In an embodiment, the action 610 can be changing driving behavior such as braking, changing direction. In another embodiment, the action 610 can be creating an exterior design plan relative to an exterior scene layout 608. In another embodiment, the action 610 can be creating an interior design plan relative to an interior scene layout 608.

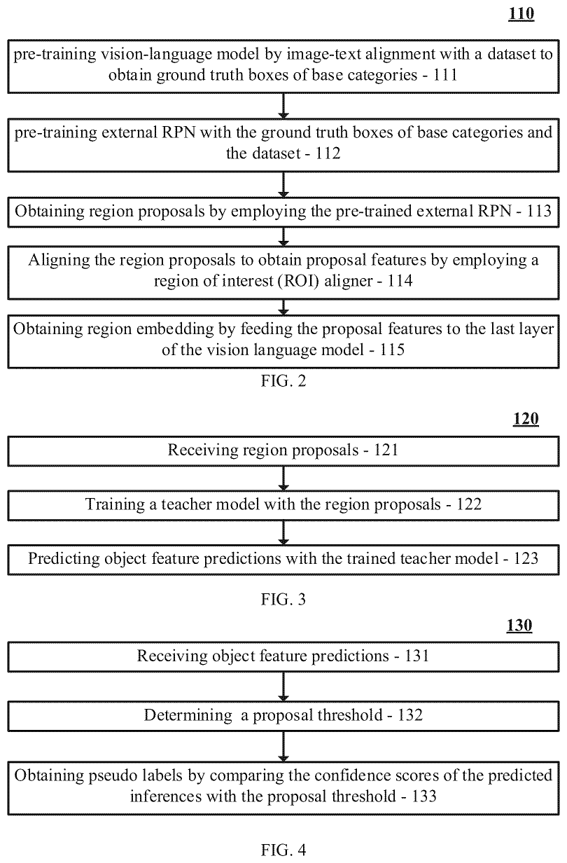

Referring now to FIG. 2, a method for obtaining region proposals by employing a pre-trained vision-language model and a pre-trained region proposal network 110 is illustratively depicted in accordance with an embodiment of the present invention.

In an embodiment, a pre-trained vision-language model 504 can be employed to obtain ground truth bounding boxes 519 of base categories. In an embodiment, a pre-trained external region proposal network 509 can be employed to obtain region proposals 510 by utilizing the ground truth bounding boxes 519 of base categories and the input dataset 501.

In block 111, a vision-language model 504 can be pre-trained by image-text alignment with an input dataset 501 to obtain ground truth bounding boxes 519 of base categories. In an embodiment, the vision-language model 504 can be a contrastive language-image pretraining (CLIP) model. Other vision-language models can be employed. In an embodiment, the common objects in context (COCO) dataset can be employed as the input dataset 501. In another embodiment, the large vocabulary instance segmentation (LVIS) dataset can be employed as the input dataset 501. The ground truth bounding boxes 519 of base categories can be bounding boxes containing base categories. Base categories are categories already learned by the VLM based on the training dataset. For example, a base category can include objects (e.g., bench, cat, dog) or people.

In block 112, an external region proposal network (RPN) 509 can be pre-trained with the ground truth bounding boxes 519 of base categories and the input dataset 501. In an embodiment, the RPN 509 can be a faster region-based convolutional neural network (RCNN). Other RPN frameworks are contemplated.

In block 113, region proposals 510 can be obtained by employing the pre-trained external RPN 509. Region proposals 510 are candidate bounding boxes that are likely to include objects of interest based on the base categories. For example, a region proposal 510 can be a bounding box that can include a base category such as a bench.

In block 114, the region proposals 510 can be aligned by employing a region of interest (ROI) aligner 521 to obtain proposal features 542.

In block 115, region embeddings can be obtained by feeding the proposal features 542 to the last layer of the vision language model. In an embodiment, for the ith region proposal from the external RPN, an alignment algorithm can be employed on the 4th feature maps of the vision-language model 504 to get the proposal features 542. The features are fed to the last layer of the VLM to get region embedding Ri. A set of given concepts with prompts (e.g, known objects such as a chair, sofa) can be converted to text embeddings that can act as classifiers. The probability of an ith region embedding to be classified as the c-th category (Pi,c) can be computed as:

$${P}_{i , c} = \frac{exp ( \frac{〈 Ri , Tc 〉}{τ} )}{{\sum }_{j = 0}^{C - 1} \frac{〈 Ri , Tc 〉}{τ}}$$

where <Ri, Tc> is the cosine distance of region embedding Ri, text embedding of category c Tc, and temperature T.

Referring now to FIG. 3, a method for obtaining object feature predictions by employing a trained a teacher neural network with the region proposals 120 is illustratively depicted in accordance with an embodiment of the present invention.

In an embodiment, a teacher neural network 511 can be trained with the region proposals 510 obtained from the external RPN. In an embodiment, the teacher neural network 511 can employ a split-and-fusion (SAF) detection head which can be periodically updated with parameters from the trained student neural network 522.

In block 121, region proposals 510 can be received for processing.

In block 122, a teacher neural network 511 can be trained with the region proposals 510. In an embodiment, the teacher neural network 511 can be pre-trained on pairs of images with corresponding captions. In an embodiment, the teacher neural network 511 can include a VLM such as CLIP.

In block 123, object feature predictions 516 can be predicted with the trained teacher neural network 511. In an embodiment, object feature predictions 516 can include the class label of the region proposal and the bounding box coordinates of the predicted object.

Referring now to FIG. 4, a method for filtering object feature predictions above a proposal threshold to obtain pseudo labels 130 is illustratively depicted in accordance with an embodiment of the present invention.

In an embodiment, pseudo labels 518 can be obtained by filtering object feature predictions 516 through a proposal threshold 517.

In block 131, object feature predictions 516 can be received for processing.

In block 132, a proposal threshold 517 can be determined. In an embodiment, an intersection over union (IoU) score can be employed to determine the proposal threshold 517. In an embodiment, the proposal threshold 517 can be 0.5 (e.g., for the COCO dataset). In another embodiment, the proposal threshold 517 can range from 0.5 to 0.95 (e.g., for the LVIS dataset).

In block 133, pseudo labels 518 can be obtained by comparing the confidence scores of the predicted inferences with the proposal threshold 517. In an embodiment, if the confidence score is greater than 0.5, then the classification of the region proposal can be the pseudo label.

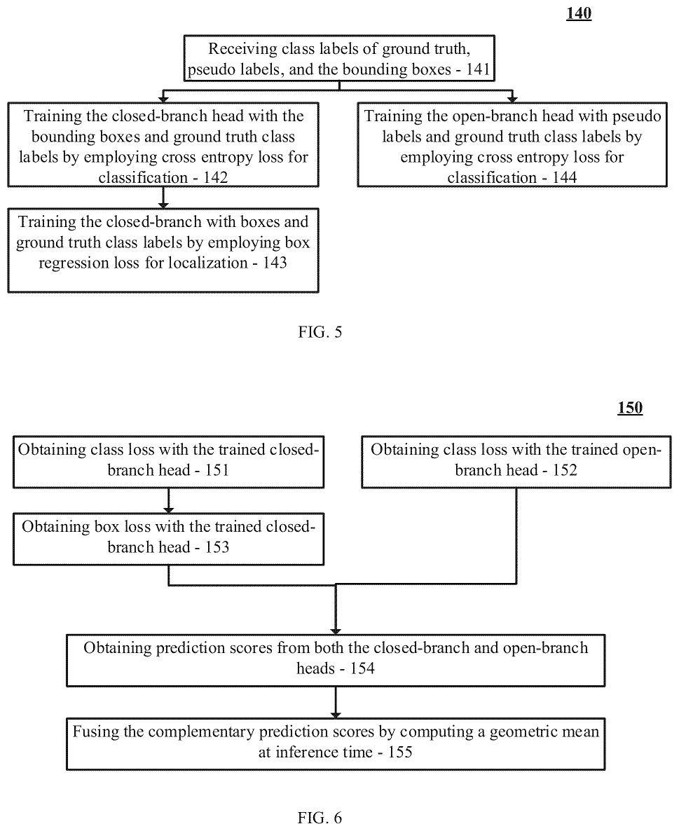

Referring now to FIG. 5, a method for training a student neural network with a split-and-fusion detection head by utilizing the region proposals, ground truth class labels and the pseudo labels 140 is illustratively depicted in accordance with an embodiment of the present invention.

In an embodiment, a detection head 523 can be split into two branches: open-branch 525 and closed-branch 524 to handle noisy pseudo labels 518 during training. At inference, predictions from both branches are fused to improve performance. In an embodiment, the closed-branch 524 can be trained with the ground truth bounding boxes 519 and ground truth class labels 520 by employing cross entropy loss for classification. In an embodiment, the closed-branch 524 can be trained with the ground truth bounding boxes 519 and ground truth class labels 520 by employing box regression loss for localization. In an embodiment, an open-branch 525 can be trained with pseudo labels 518 and ground truth class labels 520 by employing cross entropy loss for classification.

In block 141, the ground truth class labels 520, pseudo labels 518 and the ground truth bounding boxes 519 can be received for processing.

In block 142, a closed-branch 524 can be trained with the ground truth bounding boxes 519 and ground truth class labels 520 by employing cross entropy loss for classification.

In block 143, the closed-branch 524 can be trained with the ground truth bounding boxes 519 and ground truth class labels 520 by employing box regression loss for localization.

In block 144, an open-branch 525 can be trained with pseudo labels 518 and ground truth class labels 520 by employing cross entropy loss for classification.

Referring now to FIG. 6, a method for optimizing pseudo labels by reducing noise from the pseudo labels by employing the trained split-and-fusion detection head of the trained student neural network 150 is illustratively depicted in accordance with an embodiment of the present invention.

In an embodiment, complementary prediction scores from both branches can be obtained. In an embodiment, closed class loss 529 (shown in FIG. 8) can be obtained by employing the trained closed-branch detection head. In an embodiment, open class loss 531 (shown in FIG. 8) can be obtained by employing the trained open-branch detection head. In an embodiment, closed box loss 528 (shown in FIG. 8) can be obtained by employing the trained closed-branch detection head.

In block 151, closed class loss 529 can be obtained by employing the trained closed-branch 524.

In block 152, open class loss 531 can be obtained by employing the trained open-branch 525.

In block 153, closed box loss 528 can be obtained by employing the trained closed-branch 524.

In block 154, prediction scores from both closed-branch 524 and open-branch 525 can be obtained. In an embodiment, the prediction scores from the closed-branch 524 can be obtained by computing the weighted average of the box loss 528 and the closed class loss 529. In an embodiment, the prediction scores from the open-branch 530 can be the open class loss 531.

In block 155, complementary prediction scores can be fused by computing a geometric mean of the prediction scores at inference time to obtain a final score by employing a fusion module 526 (shown in FIG. 8). In an embodiment, the complementary prediction scores can be predictions scores from both the open-branch 525 and closed-branch 524 that relate to a common object detection category. The category can be a base category C^{b} or a novel category C^{N}. In an embodiment, a novel category is a category newly discovered by the system and is not included in the base categories of the input dataset 501.

The final score can be computed as:

$${P}_{final} = \{ \begin{matrix}{( {P}_{i , c}^{closed} )}^{( 1 - α )} \cdot {( {P}_{i , c}^{open} )}^{α} , if i ∈ {C}^{b} \\ {( {P}_{i , c}^{closed} )}^{α} \cdot {( {P}_{i , c}^{open} )}^{( 1 - α )} , if i ∈ {C}^{N}\end{matrix}$$

where i is an element of categories C, C^{b} is a base category, C^{N} is a novel, open category, P_{i,c}^{closed} is the prediction score of the closed-branch of i and category c, P_{i,c}^{open} is the prediction score of the closed-branch of i and category c, and a € [0, 1].

Referring now to FIG. 7, a system for method for optimizing models for open-vocabulary detection 500 is illustratively depicted, in accordance with one embodiment of the present invention.

The computing device 500 illustratively includes the processor device 594, an input/output (I/O) subsystem 590, a memory 591, a data storage device 592, and a communication subsystem 593, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 591, or portions thereof, may be incorporated in the processor device 594 in some embodiments.

The processor device 594 may be embodied as any type of processor capable of performing the functions described herein. The processor device 594 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 591 may be embodied as any type of volatile or non-volatile memory or data storage capable of performing the functions described herein. In operation, the memory 591 may store various data and software employed during operation of the computing device 500, such as operating systems, applications, programs, libraries, and drivers. The memory 591 is communicatively coupled to the processor device 594 via the I/O subsystem 590, which may be embodied as circuitry and/or components to facilitate input/output operations with the processor device 594, the memory 591, and other components of the computing device 500. For example, the I/O subsystem 590 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 590 may form a portion of a system-on-a-chip (SOC) and be incorporated, along with the processor device 594, the memory 591, and other components of the computing device 500, on a single integrated circuit chip.

The data storage device 592 may be embodied as any type of device or devices configured for short-term or long-term storage of data such as, for example, memory devices and circuits, memory cards, hard disk drives, solid state drives, or other data storage devices. The data storage device 592 can store program code for optimizing models for open-vocabulary detection 100. Any or all of these program code blocks may be included in a given computing system.

The communication subsystem 593 of the computing device 500 may be embodied as any network interface controller or other communication circuit, device, or collection thereof, capable of enabling communications between the computing device 500 and other remote devices over a network. The communication subsystem 593 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 595. The peripheral devices 595 may include any number of additional input/output devices, interface devices, and/or other peripheral devices. For example, in some embodiments, the peripheral devices 595 may include a display, touch screen, graphics circuitry, keyboard, mouse, speaker system, microphone, network interface, and/or other input/output devices, interface devices, GPS, camera, and/or other peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the processing system 500 are readily contemplated by one of ordinary skill in the art given the teachings of the present invention provided herein.

Referring now to FIG. 8, a system for optimizing models for open-vocabulary detection is illustratively depicted, in accordance with one embodiment of the present invention.

In an embodiment, a pre-trained vision language model 504 can be employed to obtain ground truth bounding boxes 519. The vision language model can include an image encoder 505 and a text encoder 506. In an embodiment, a pre-trained external region proposal network 509 can be employed to obtain region proposals 510.

In an embodiment, a teacher neural network 511 can be employed to obtain object feature predictions 516. The object feature predictions 516 can be compared against a proposal threshold 517 to obtain pseudo labels 518. The teacher neural network 511 can include a teacher split-and-fusion (SAF) detection head 512. The teacher SAF detection head 512 can further include a teacher closed-branch 513, teacher open branch 514, and a teacher fusion module 515. In an embodiment, a region of interest aligner 521 can be employed to align the region proposals 510.

In an embodiment, the region proposals 510, pseudo labels 518, ground truth bounding boxes 519 and ground truth class labels 520 can be utilized to train a student neural network 522 and obtain optimized pseudo labels 540 and optimized object detections 541. In an embodiment, the student neural network 522 can include a student SAF detection head 523. In an embodiment, the student SAF detection head 523 can include student closed-branch 524, student open-branch 525 and student fusion module 526.

In an embodiment, a periodic updater 532 can be employed to update the parameters of the teacher neural network 511 to conform with the parameters of the student neural network 522.

Referring now to FIG. 9, a system for optimizing models for open-vocabulary detection 600 is illustratively depicted, in accordance with one embodiment of the present invention.

In an embodiment, an entity 601 can capture a current image 603 by utilizing a camera 602. Entity 601 sends the current image 603 over a network 604 to send the current image 603 to the computer system 605. The computer system 605 can implement the computer-implemented method for optimizing models for open-vocabulary detection 100 and can obtain optimized object detections 606 based on the optimized pseudo labels 540. The optimized object detections 541 can be further processed to obtain a scene layout 608. The scene layout 608 can be interpreted by the decision-making entity 609 to execute an action 610.

In an embodiment for traffic analysis, the optimized object detections 606 can be traffic scene objects such as cars, buildings, pedestrians, animals (e.g., dogs, cats), traffic signs, light posts, etc. The decision-making entity 609 can interpret a scene layout 608 to execute an action 610 such as changing driving behaviors (e.g., changing direction, speeding up, braking, etc.) relative to the scene layout 608. In another embodiment, the system 600 can update route trajectories of a vehicle relative to a scene layout 608 with the optimized object detections 606 by employing a trajectory model that computes the appropriate route trajectory based on current driving conditions (e.g., traffic flow, speed of vehicle, adjacent traffic, etc.) and the scene layout 608. In another embodiment, the system 600 can control the vehicle (e.g., braking, change directions) relative to a scene layout with the optimized object detections 606.

In an embodiment for exterior design, the optimized object detections 606 can be exterior design objects such as buildings, tables, benches, animals (e.g., dogs, cats), light posts, walls, rocks, etc. The decision-making entity 609 can interpret a scene layout 608 to execute an action 610 such as creating an exterior design plan relative to the scene layout 608. In another embodiment, the system 600 can create an exterior design plan relative to the scene layout 608. The action 610 can be that the decision-making entity 609 can approve the created exterior design plan and send it to the appropriate entity involved.

In an embodiment for interior design, the optimized object detections 606 can be interior design objects such as tables, chairs, appliances, animals (e.g., dogs, cats), light fixtures, walls, etc. The decision-making entity 609 can interpret a scene layout 608 to execute an action 610 such as creating an interior design plan relative to the scene layout 608. In another embodiment, the system 600 can create an interior design plan relative to the scene layout 608. The action 610 can be that the decision-making entity 609 can approve of the interior design plan and send it to the appropriate entity involved. Other practical applications are contemplated.

In an embodiment, neural networks can be employed, such as the vision-language model 504, the external RPN model, the teacher neural network 511 and the student neural network 522.

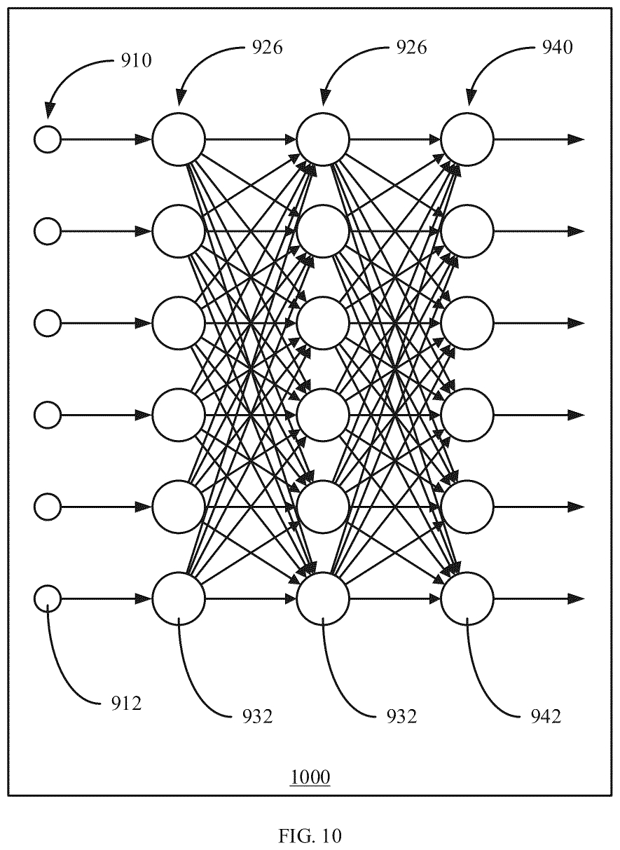

Referring now to FIG. 10, an overview of deep learning neural networks is illustratively depicted, in accordance with one embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In FIG. 10, a deep neural network is shown. The deep neural network 1000, such as a multilayer perceptron, can have an input layer 911 of source nodes 912, one or more computation layer(s) 926 having one or more computation nodes 932, and an output layer 940, where there is a single output node 942 for each possible category into which the input example could be classified. An input layer 911 can have a number of source nodes 912 equal to the number of data values 912 in the input data 911. The computation nodes 932 in the computation layer(s) 926 can also be referred to as hidden layers, because they are between the source nodes 912 and output node(s) 942 and are not directly observed. Each node 932, 942 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

In an embodiment, the computation layers 926 of the closed-branch (e.g. teacher closed-branch 513 and student closed-branch 524) can compute a box loss by utilizing the ground truth class labels 520 and the ground truth bounding boxes 519. The output layer 940 of the closed-branch (e.g. teacher closed-branch 513 and student closed-branch 524) can provide the overall response of the network in a form of a box loss. In another embodiment, the computation layers 926 of the closed-branch (e.g. teacher closed-branch 513 and student closed-branch 524) can compute a class loss by utilizing the ground truth class labels 520 and the ground truth bounding boxes 519. The output layer 940 of the closed-branch (e.g. teacher closed-branch 513 and student closed-branch 524) can provide the overall response of the network in the form of a class loss. In another embodiment, the computation layers 926 of the open-branch (e.g. teacher open-branch 514 and student open-branch 525) can compute a class loss by utilizing the ground truth class labels 520 and the pseudo labels. The output layer 940 of the open-branch (e.g. teacher open-branch 514 and student open-branch 525) can provide the overall response of the network in a form of a class loss.

Training a deep neural network can involve two phases, a forward phase where the weights of each node are fixed and the input propagates through the network, and a backwards phase where an error value is propagated backwards through the network and weight values are updated.

The computation nodes 932 in the one or more computation (hidden) layer(s) 926 perform a nonlinear transformation on the input data 912 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for optimizing models for open-vocabulary detection, comprising:
obtaining region proposals by employing a pre-trained vision-language model and a pre-trained region proposal network;
obtaining object feature predictions by employing a trained teacher neural network with the region proposals;
filtering object feature predictions above a proposal threshold to obtain pseudo labels;
training a student neural network with a split-and-fusion detection head by utilizing the region proposals, ground truth class labels, ground truth bounding boxes, and the pseudo labels;
optimizing the pseudo labels by reducing noise from the pseudo labels by employing the trained split-and-fusion detection head of the trained student neural network to obtain optimized object detections; and
performing an action relative to a scene layout with the optimized object detections.

2. The computer-implemented method of claim 1, further comprising periodically updating the teacher neural network with parameters of the student neural network to self-train the teacher neural network and the student neural network.

3. The computer-implemented method of claim 1, wherein optimizing the pseudo labels further comprises splitting a detection head into a closed-branch and an open-branch to obtain optimized pseudo labels.

4. The computer-implemented method of claim 3, wherein the closed-branch is trained with ground truth bounding boxes and ground truth class labels.

5. The computer-implemented method of claim 4, wherein the trained closed-branch employs cross entropy loss to obtain class loss for classification.

6. The computer-implemented method of claim 4, wherein the trained closed-branch employs box regression loss to obtain box loss for localization.

7. The computer-implemented method of claim 3, wherein the open-branch is trained with the pseudo labels and ground truth class labels.

8. The computer-implemented method of claim 7, wherein the open-branch employs cross entropy loss to obtain class loss for classification.

9. The computer-implemented method of claim 1, wherein optimizing the pseudo labels further comprises fusing prediction scores of a closed-branch and an open-branch of the detection head by computing a geometric mean of the prediction scores at inference time to obtain optimized pseudo labels.

10. A system for optimizing models for open-vocabulary detection, comprising:
a memory;
one or more processor devices in communication with the memory configured to:
obtain region proposals by employing a pre-trained vision-language model and a pre-trained region proposal network;
obtain object feature predictions by employing a trained teacher neural network with the region proposals;
filter object feature predictions above a proposal threshold to obtain pseudo labels;
train a student neural network with a split-and-fusion detection head by utilizing the region proposals, base ground truth class labels, ground truth bounding boxes, and the pseudo labels;
optimize the pseudo labels by reducing noise from the pseudo labels by employing the trained split-and-fusion detection head of the trained student neural network to obtain optimized object detections; and
perform an action relative to a scene layout with the optimized object detections.

11. The system of claim 10, further comprising to periodically update the teacher neural network with parameters of the student neural network to self-train the teacher neural network and the student neural network.

12. The system of claim 10, wherein to optimize the pseudo labels further comprises to split a detection head into a closed-branch and an open-branch to obtain optimized pseudo labels.

13. The system of claim 12, wherein the closed-branch is trained with ground truth bounding boxes and ground truth class labels.

14. The system of claim 13, wherein the trained closed-branch employs cross entropy loss to obtain class loss for classification.

15. The system of claim 13, wherein the trained closed-branch employs box regression loss to obtain box loss for localization.

16. The system of claim 12, wherein the open-branch is trained with the pseudo labels and ground truth class labels.

17. The system of claim 16, wherein the open-branch employs cross entropy loss to obtain class loss for classification.

18. The system of claim 10, wherein to optimize the pseudo labels further comprises to fuse prediction scores of a closed-branch and an open-branch of the detection head by computing a geometric mean of the prediction scores at inference time to obtain optimized pseudo labels.

19. A non-transitory computer program product comprising a computer-readable storage medium including program code for optimizing models for open-vocabulary detection wherein the program code when executed on a computer causes the computer to perform:
obtaining region proposals by employing a pre-trained vision-language model and a pre-trained region proposal network;
obtaining object feature predictions by employing a trained teacher neural network with the region proposals;
filtering object feature predictions above a proposal threshold to obtain pseudo labels;
training a student neural network with a split-and-fusion detection head by utilizing the region proposals, base ground truth class labels, ground truth bounding boxes, and the pseudo labels;
optimizing the pseudo labels by reducing noise from the pseudo labels by employing the trained split-and-fusion detection head of the trained student neural network to obtain optimized object detections by fusing prediction scores from a closed-branch and an open-branch by computing a geometric mean of the prediction scores at inference time; and
performing an action relative to a scene layout with the optimized object detections.

20. The non-transitory computer program product of claim 19, further comprising periodically updating the teacher neural network with parameters of the student neural network to self-train the teacher neural network and the student neural network.
